(19) United States
(12) Patent Application Publication
(10) Pub. No.: US 2021/0304738 A1
(43) Pub. Date: Sep. 30, 2021

(54) INFORMATION PROVIDING SYSTEM, INFORMATION PROVIDING DEVICE, AND CONTROL METHOD OF INFORMATION PROVIDING DEVICE

(71) Applicant: HONDA MOTOR CO., LTD., Tokyo (JP)

(72) Inventors: Akira Terauchi, Wako-shi (JP); Naoko Imai, Wako-shi (JP); Atsuyuki Suzuki, Wako-shi (JP)

(21) Appl. No.: 17/208,112

(22) Filed: Mar. 22, 2021

(30) Foreign Application Priority Data
Mar. 25, 2020 (JP) 2020-054662

(51) Int. Cl. G10L 15/18; G10L 15/22; G06Q 30/06; B60W 50/10

(52) U.S. Cl. CPC G10L 15/1815; G10L 15/22; B60W 2540/21; B60W 50/10; G06Q 30/0631

(57) ABSTRACT

An information providing device is disposed on a movable body, and includes a microphone that collects voice uttered by a user of the movable body, a movable body communication unit that transmits utterance data on the voice collected by the microphone to a server and receives recommendation information of a product or service generated by a server-side processor of the server based on the utterance data, a recommendation information storage unit that stores the recommendation information, and a recommendation information output unit that outputs the recommendation information during stop of the movable body.

### INCORPORATION BY REFERENCE

The present application claims priority under 35 U.S.C.§ 119 to Japanese Patent Application No. 2020-054662 filed on Mar. 25, 2020. The content of the application is incorporated herein by reference in its entirety.

### BACKGROUND OF THE INVENTION

### Field of the Invention

The present invention relates to an information providing system, an information providing device, and a control method of the information providing device.

### Description of the Related Art

Conventionally, a technique has been proposed in which a device mounted on a vehicle provides a user with personal assistance, thereby recognizes an event such as the user placing an object, and reminds the user of the event (for example, see Japanese Patent Laid-Open No. 2019-32843). When a device described in Japanese Patent Laid-Open No. 2019-32843 recognizes, for example, an event that a user places a key, the device actively and automatically outputs data related to the position of the key.

Information useful for users of movable bodies such as vehicles is not limited to information on events that the users themselves did, but various information can be considered. In addition, timing when the users are provided with information is desired to be appropriate.

An object of the present invention, which has been made in view of such background, is to effectively provide information useful for users of movable bodies at appropriate timing.

### SUMMARY OF THE INVENTION

As a first aspect for achieving the above objective, there is mentioned an information providing system comprising a movable body terminal device disposed on a movable body and a server capable of communicating with the movable body terminal device, wherein: the movable body terminal device includes a terminal device-side processor, a terminal device-side memory, and a microphone for collecting voice uttered by a user on board the movable body, wherein the terminal device-side processor functions as a communication control unit for transmitting utterance data on the voice collected by the microphone; and the server includes a server-side processor, wherein the server-side processor functions as a server communication unit for receiving the utterance data, a voice recognition unit for recognizing utterance contents of the user based on the utterance data, a semantic interpretation unit for interpreting the utterance contents of the user based on a recognition result of the voice recognition unit, and a recommendation information generation unit for generating recommendation information of a product or service based on a result of interpretation processing of the semantic interpretation unit, wherein the terminal device-side processor functions as a recommendation information output unit for outputting the recommendation information during stop of the movable body.

The information providing system may be configured such that the server outputs, by a function of the server communication unit, the result of the interpretation processing by a function of the semantic interpretation unit of the server-side processor and/or the recommendation information; and the terminal device-side processor of the movable body terminal device receives, by a function of the communication control unit, the result of the interpretation processing and/or the recommendation information, stores the result of the interpretation processing and/or the recommendation information in the terminal device-side memory, further functions as a user action recognition unit for recognizing the user's action, and outputs the recommendation information stored in the terminal device-side memory by a function of the recommendation information output unit when a specific action from which the user is presumed to get out of the movable body is recognized by a function of the user action recognition unit.

The information providing system may be configured such that the terminal device-side processor of the movable body terminal device transmits positional information on the movable body to the server by a function of the communication control unit; and the server-side processor of the server receives the positional information on the movable body by a function of the server communication unit, and generates the recommendation information by a function of the recommendation information generation unit based on the positional information on the movable body and the result of the interpretation processing by a function of the semantic interpretation unit.

The information providing system may be configured such that the terminal device-side processor of the movable body terminal device transmits a user profile of the user to the server by a function of the communication control unit; and the server-side processor of the server receives the user profile by a function of the server communication unit, and generates the recommendation information by a function of the recommendation information generation unit based on the user profile and the result of the interpretation processing by a function of the semantic interpretation unit.

The information providing system may be configured such that the server-side processor of the server transmits, by a function of the server communication unit, a trigger keyword that triggers transmission of the utterance data; and the terminal device-side processor of the movable body terminal device stores the trigger keyword received by a function of the communication control unit in the terminal device-side memory, further functions as a keyword detection unit for detecting the trigger keyword from the voice collected by the microphone, and transmits the utterance data on the utterance voice including the trigger keyword by a function of the communication control unit when the trigger keyword is detected by a function of the keyword detection unit.

The information providing system may be configured such that the terminal device-side memory stores the voice collected by the microphone; and the terminal device-side processor transmits, by the function of the communication control unit, the utterance data on an utterance voice including the trigger keyword and voice during a predetermined time before and after the utterance voice when the trigger keyword is detected by the function of the keyword detection unit.

As a second aspect for achieving the above objective, there is mentioned an information providing device disposed on a movable body, the information providing device comprising a processor, a memory, and a microphone for collecting voice uttered by a user of the movable body, wherein: the processor functions as a communication control unit for transmitting utterance data on the voice collected by the microphone to a server and receiving recommendation information of a product or service generated by a server-side processor of the server based on the utterance data; the memory stores the recommendation information; and the processor functions as a recommendation information output unit for outputting the recommendation information during stop of the movable body.

The information providing device may be configured such that the processor functions as a user action recognition unit for recognizing an action of the user on board the movable body, and outputs the recommendation information stored in the memory by a function of the recommendation information output unit when a specific action from which the user is presumed to get out of the movable body is recognized by a function of the user action recognition unit.

The information providing device may be configured such that the processor functions as a service request reception unit for receiving a purchase operation based on the recommendation information, and transmits, by a function of the communication control unit, a purchase request based on the recommendation information output by a function of the recommendation information output unit when the purchase operation is received by a function of the service request reception unit.

As a third aspect for achieving the above objective, there is mentioned a control method of an information providing device executed by a processor of the information providing device disposed on a movable body, the control method comprising: collecting voice uttered by a user of the movable body by a microphone; transmitting utterance data on the voice collected by the microphone to a server; receiving recommendation information of a product or service generated by a server-side processor of the server based on the utterance data; storing the recommendation information; and outputting the recommendation information during stop of the movable body.

According to the above configurations, information on a product or service related to contents uttered by a user of a movable body is provided when the movable body is stopped. Thereby, by outputting the recommendation information of the product or service in a state where the user is released from movement by the movable body and relaxed and able to pay attention to the recommendation information, useful information can be provided at appropriate timing.

### BRIEF DESCRIPTION OF THE DRAWINGS

FIG. 1 is an explanatory diagram illustrating an outline of an information providing system;

FIG. 2 is a configuration diagram of a vehicle equipped with an information providing device;

FIG. 3 is a configuration diagram of the information providing device;

FIG. 4 is a block diagram of an information providing server;

FIG. 5 is a sequence diagram illustrating operation of the information providing system;

FIG. 6 is a flowchart illustrating operation of the information providing device;

FIG. 7 is a flowchart illustrating operation of the information providing server;

FIG. 8 is a flowchart illustrating operation of the information providing device; and

FIG. 9 is a diagram illustrating one example of a recommendation screen.

### DETAILED DESCRIPTION OF THE PREFERRED EMBODIMENTS

### [1. Outline of Information Providing System]

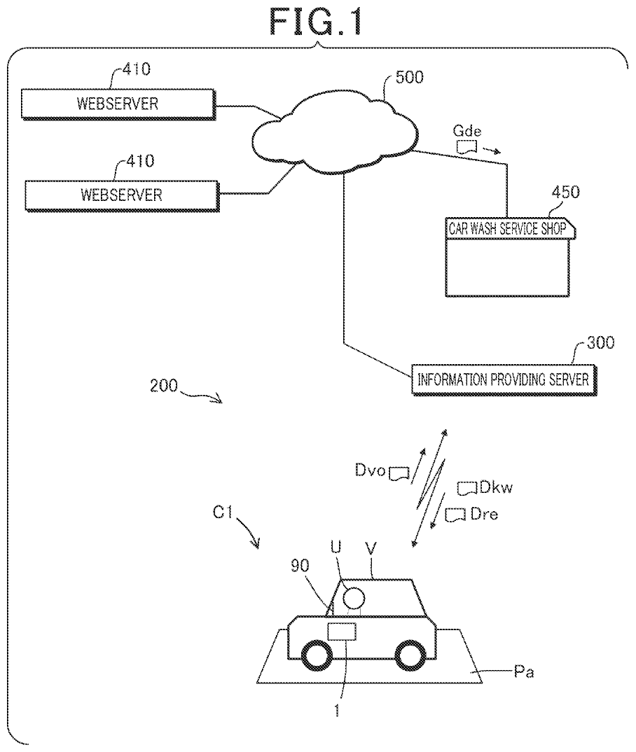

An outline of an information providing system 200 of an embodiment will be described with reference to FIG. 1.

The information providing system 200 is a system in which an information providing device 1 mounted on a vehicle V communicates with an information providing server 300 via a communication network 500, and provides recommendation information for a user U on board the vehicle V. The vehicle V corresponds to a movable body of the present invention.

As shown in C1 of FIG. 1, the information providing device 1 displays a recommendation screen on a touch panel 90 while the vehicle V is stopping, more specifically, at timing when the vehicle V is parked at a parking spot Pa and an action of the user U getting out of the vehicle V is recognized.

The recommendation screen contains information for proposing purchase of a product or use of a service to the user U and includes an input unit for applying for purchase of the product or use of the service. The user U can simply apply for purchase of the product or use of the service by operating the input unit of the recommendation screen.

Here, in a situation where the user U gets out, it is assumed that the user U is released from strain of driving the vehicle V which the user has done so far, relaxes, and naturally gazes at the recommendation screen displayed on the touch panel 90. Therefore, it is expected that an appearing effect of the recommendation screen is extremely high.

The information providing server 300 communicates with one or more webservers 410 through the communication network 500. Each of the webservers 410 is a server that receives sales of a product or provision of a service, and transmits information on the product or service to be sold to the information providing server 300 in response to a request from the information providing server 300.

The product or service proposed to the user U by the recommendation screen is determined by the information providing server 300 acquiring the information from the webserver 410.

The webserver 410 may have a function of arranging or making settlement for a product or service when the user U operates the information providing device 1 to instruct purchase of the product or service. For example, when the user U instructs use of a car wash service by the recommendation screen, the webserver 410 transmits a reservation reception instruction Gde to a car wash service shop 450. Thereby, the user U can request the car wash service shop 450 to wash the vehicle V.

The information providing device 1 acquires voice uttered inside the vehicle V by the user U and transmits data on the acquired voice to the information providing server 300. The information providing server 300 recognizes contents uttered by the user U and generates recommendation information based on the uttered contents. The information providing device 1 receives the recommendation information from the information providing server 300 and displays the recommendation screen based on the received recommendation information. The information providing server 300 may generate the recommendation information by reflecting positional information on the vehicle V or a profile of the user U.

### [2. Configuration of Vehicle]

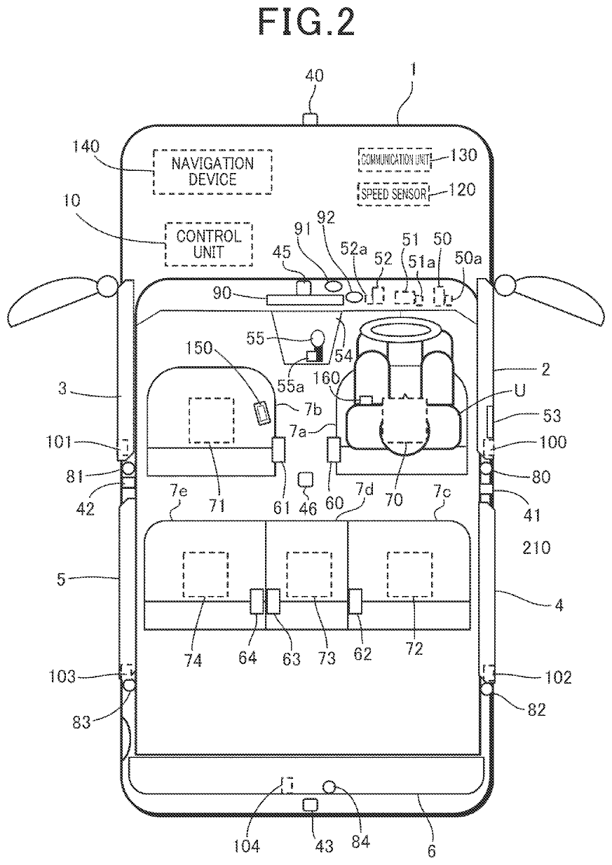

A configuration of the vehicle V equipped with the information providing device 1 will be described with reference to FIG. 2. The vehicle V is a passenger car with a seating capacity of five people, and has a driver's seat 7a, a passenger seat 7b, a rear right seat 7c, a rear center seat 7d, and a rear left seat 7e. The seats 7a-7e are provided with seatbelt switches 60-64 for detecting whether seatbelts (not shown) are fastened, and seating sensors 70-74, respectively.

FIG. 2 illustrates a situation where the user U holding a portable key 160 of the vehicle V is seated in the driver's seat 7a. In addition, a user terminal 150 used by the user U is placed on the passenger seat 7b. The vehicle V has a right front door 2, a left front door 3, a right rear door 4, and a left rear door 5, and a door knob of the right front door 2 is provided with a door touch sensor 53. The user U holding the portable key 160 can unlock the doors 2-6 of the vehicle V by touching the door touch sensor 53.

A front camera 40 for photographing forward of the vehicle V is provided at a front potion of the vehicle V, and a rear camera 43 for photographing rearward of the vehicle V is provided at a rear portion of the vehicle V. A right-side camera 41 for photographing a right-side direction of the vehicle V is provided at a right-side portion of the vehicle V, and a left-side camera 42 for photographing a left-side direction of the vehicle V is provided at a left-side portion of the vehicle V.

A dashboard of a vehicle interior is provided with a front seat camera 45 for photographing users seated in the driver's seat 7a and the passenger seat 7b, the touch panel 90, a speaker 91, and a microphone 92. A ceiling of the vehicle interior is provided with a rear seat camera 46 for photographing users seated in the rear right seat 7c, rear center seat 7d, and rear left seat 7e.

The microphone 92 collects voice. The microphone 92 is provided for collecting voice uttered by the people on board the vehicle V. For example, the microphone 92 is disposed on the dashboard, a roof console, or the like so as to easily collect voice uttered by the user U who drives the vehicle V and the person seated in the passenger seat 7b. A plurality of microphones 92 may be provided in the interior of the vehicle V. For example, a microphone for collecting voice uttered by the people seated in the rear right seat 7c, rear center seat 7d, and rear left seat 7e may be provided at a position different from the dashboard.

The doors 2-5 are provided with door switches 80-83 for detecting opening and closing of the doors, respectively. A tail gate 6 is also provided with a door switch 84 for detecting opening and closing of the tail gate 6. Furthermore, a power switch 54 and a shift switch 55a for detecting a shift position of a shift lever 55 are provided near the driver's seat 7a. The vehicle V includes an accelerator pedal sensor 50a for detecting pedaling force on an accelerator pedal 50, a brake pedal sensor 51a for detecting pedaling force on a brake pedal 51, and a side-brake switch 52a for detecting on/off of a side-brake pedal 52.

The vehicle V further includes door lock mechanisms 100-104 for locking the doors 2-5 and tail gate 6 respectively, a speed sensor 120 for detecting travel speed of the vehicle V, a communication unit 130 (receiver/transmitter), and a navigation device 140. The communication unit 130 includes an antenna, and communicates with the user terminal 150, portable key 160, information providing server 300, and the like. The navigation device 140 includes a GPS (Global Positioning System) sensor (not shown) and map data, and executes route guidance to a destination and the like based on a position of the vehicle V detected by the GPS sensor and the map data. The communication unit 130 corresponds to one example of a movable body communication unit. The communication unit 130 may form part of the information providing device 1.

### [3. Configuration of Information Providing Device]

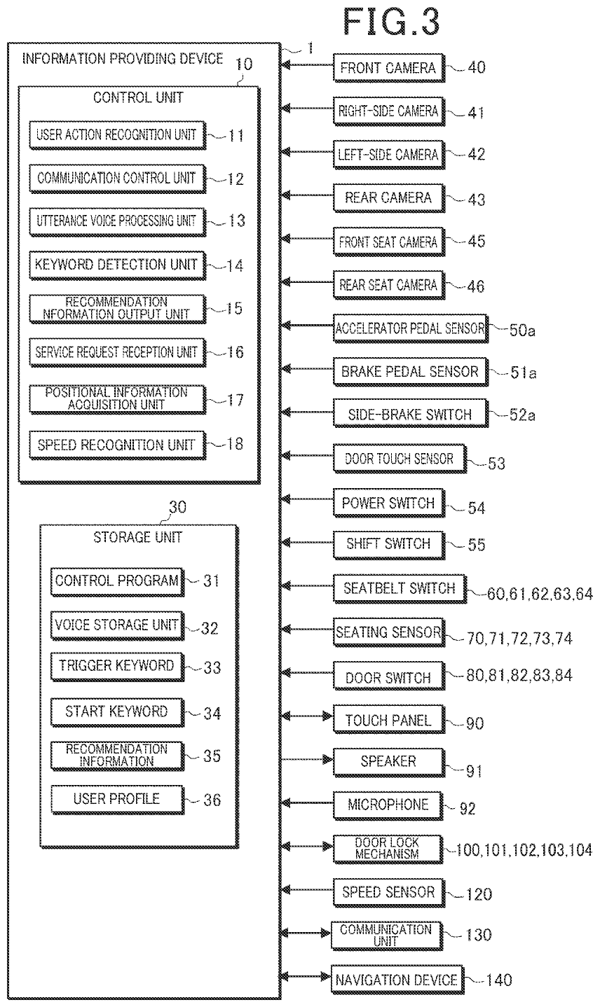

A configuration of the information providing device 1 will be described with reference to FIG. 3. The information providing device 1 includes a control unit 10 for controlling each unit of the information providing device 1 and a storage unit 30 for storing a program and data. The control unit 10 executes a control program 31 stored in the storage unit 30 by a processor such as a CPU (Central Processing Unit) or microcomputer, and implements various functions of the information providing device 1. FIG. 3 illustrates, as functional units configured by the control unit 10, a user action recognition unit 11, a communication control unit 12, an utterance voice processing unit 13, a keyword detection unit 14, a recommendation information output unit 15, a service request reception unit 16, a positional information acquisition unit 17, and a speed recognition unit 18. These functional units are implemented by collaboration of software and hardware, for example, by the processor executing the program. The control unit 10 may be equipped with hardware corresponding to those functional units. The control unit 10 may include an interface circuit (not shown).

The storage unit 30 is composed of a semiconductor memory or magnetic recording device, and stores a program and data in a non-volatile manner. The storage unit 30 stores a trigger keyword 33, a start keyword 34, recommendation information 35, and a user profile 36 in addition to the control program 31. The storage unit 30 corresponds to one example of a keyword storage unit. A voice storage unit 32 is provided using a storage area of the storage unit 30.

The voice storage unit 32 is a memory having a storage area for temporarily storing voice data, functions as a ring buffer, and stores latest voice data for a predetermined time output by the utterance voice processing unit 13 as described later.

The trigger keyword 33 is a specific word or phrase that triggers a process in which the information providing system 200 generates and outputs recommendation information. The trigger keyword 33 is detected by the keyword detection unit 14 from voice collected by the microphone 92 as described later. Because of this, the trigger keyword is preferably a word or phrase which the user U may utter in free conversation, and is preferably a short word or phrase so that it may be used in free conversation. The trigger keyword 33 is not limited to one specific word or phrase, but may include a plurality of related words or phrases. The trigger keyword 33 is delivered by the information providing server 300 to the information providing device 1 at a predetermined cycle as described later.

The trigger keyword 33 can be a word related to a name or contents of a product or service that has become a social trend. For example, when seasonal infectious diseases are prevalent, names of hygiene products such as masks, medicines, health foods, and the like can be the trigger keyword 33. For example, when seasonal events are held at schools and companies, such as entrance ceremonies, graduation ceremonies, athletic meet, school festivals, summer vacation, and entrance ceremonies, phrases related to the events can be the trigger keyword 33.

The trigger keyword 33 may be selected based on information on the user U's personal attributes or experience. For example, the trigger keyword 33 may be extracted from the user U's purchase history or service use history, and phrases related to the user U's hobbies and tastes or social attributes such as occupation and family structure can be the trigger keyword 33. For example, if a family includes an infant, diapers, milk, baby food, and the like can be the trigger keyword 33. For example, if the user U's family includes a school child or student, names of school supplies, drinks, sweets, and the like can be the trigger keyword 33. For example, when the user U's family includes an elderly person, names of care food, care products, and the like can be the trigger keyword 33. When the user U keeps a pet, names of pet food, pet breeding supplies, and the like can be the trigger keyword 33.

The trigger keyword 33 may be a word or phrase related to goods or services required according to weather or a season. For example, a studless tire may be selected as the trigger keyword 33 during a snowfall season, and names of hot season countermeasure products such as parasols can be the trigger keyword 33 based on the weather forecast.

The trigger keyword 33 may be a word or phrase related to a destination set in the navigation device 140 or a route guided by the navigation device 140. For example, names of tourist spot specialties, tourist facilities, and the like can be the trigger keyword 33.

The trigger keyword 33 may be a word or phrase related to a schedule of the user U. For example, in a configuration in which the information providing server 300 can acquire information from a schedule information server (not shown) that manages schedule information of the user U, names of goods required in an action schedule of the user U, services related to the action schedule, and the like can be the trigger keyword 33.

The start keyword 34 is preset as a word or phrase by which the user U instructs the information providing system 200 to start. When the user U wants to intentionally instruct the information providing system 200 to start operation, the user U utters the start keyword 34. That is, the start keyword 34 is a word or phrase for instruction recognized by the user U.

The recommendation information 35 is information included in recommendation information Dre transmitted by the information providing server 300 to the information providing device 1. When voice uttered by the user U includes the trigger keyword 33, the recommendation information Dre is generated and transmitted by the information providing server 300 as information related to the trigger keyword 33 uttered by the user U.

The user profile 36 is information on the user U who uses the vehicle V and is stored in the storage unit 30 in advance. The user profile 36 may be acquired from the user terminal 150, for example, by the information providing device 1 communicating with the user terminal 150. The user U may operate the touch panel 90 and input the user profile 36. The user profile 36 may be extracted from the user U's purchase history or service use history, and may include information indicating the user U's hobbies and tastes or social attributes such as occupation and family structure. The user profile 36 may include positional information on the user U's residential area and work place. In addition, the user profile 36 may include information on a schedule of the user U.

Images around the vehicle V taken with the front camera 40, right-side camera 41, left-side camera 42, and rear camera 43 are input to the information providing device 1. Images in the interior of the vehicle V taken with the front seat camera 45 and rear seat camera 46 are also input to the information providing device 1. A voice signal of voice collected by the microphone 92 is input to the information providing device 1 from the microphone 92. The microphone 92 may form part of the information providing device 1.

Detection signals of the accelerator pedal sensor 50a, brake pedal sensor 51a, side-brake switch 52a, door touch sensor 53, power switch 54, shift switch 55a, seatbelt switches 60-64, seating sensors 70-74, and door switches 80-84, and lock detection signals of the doors 2-5 and tail gate 6 by the door lock sensors (not shown) provided in the door lock mechanisms 100-104 are input to the information providing device 1.

A touch position detection signal of the touch panel 90, a speed detection signal of the speed sensor 120, and information on the current position (latitude and longitude) of the vehicle V detected by the navigation device 140 are input to the information providing device 1.

Screen display of the touch panel 90 and sound (such as voice guidance and chime sound) output from the speaker 91 are controlled by a control signal output from the information providing device 1.

The user action recognition unit 11 recognizes an action of the user U based on the captured images around the vehicle V taken with the front camera 40, right-side camera 41, left-side camera 42, and rear camera 43, the captured images in the interior of the vehicle V taken with the front seat camera 45 and rear seat camera 46, the detection signals of the accelerator pedal sensor 50a, brake pedal sensor 51a, side-brake switch 52a, door touch sensor 53, power switch 54, shift switch 55a, seatbelt switches 60-64, seating sensors 70-74, and door switches 80-84, the lock detection signals of the doors 2-5 and tail gate 6 by the door lock sensors (not shown) provided in the door lock mechanisms 100-104, and the like.

The communication control unit 12 controls the communication unit 130 to communicate with the user terminal 150, portable key 160, information providing server 300, and the like. The communication control unit 12 stores information received from the information providing server 300 in the storage unit 30 as needed.

The utterance voice processing unit 13 converts and processes the voice signal collected by the microphone 92 into digital voice data. The utterance voice processing unit 13 stores the voice data in the voice storage unit 32.

The keyword detection unit 14 analyzes the voice data output by the utterance voice processing unit 13 and detects voice corresponding to the trigger keyword 33. The keyword detection unit 14 also analyzes the voice data output by the utterance voice processing unit 13 and detects voice corresponding to the start keyword 34. In these processes, for example, the keyword detection unit 14 performs a voice recognition process for the voice data, converts the voice data into text data, and detects the trigger keyword 33 and start keyword 34 in the converted text data.

The utterance voice processing unit 13 generates utterance data Dvo when the trigger keyword 33 is detected by the keyword detection unit 14. The utterance data Dvo includes data on voice when the keyword detection unit 14 detects the trigger keyword 33 and data on voice uttered before and after the voice corresponding to the trigger keyword 33. That is, the utterance voice processing unit 13 extracts, from the voice data stored in the voice storage unit 32, the voice data on the trigger keyword 33 detected by the keyword detection unit 14, the voice data collected during a predetermined time before the trigger keyword 33, and the voice data collected during a predetermined time after the trigger keyword 33. The predetermined time may be preset, for example, in units of seconds, or the utterance voice processing unit 13 may detect a break in the utterance of the user U and determine the predetermined time. The utterance data Dvo generated by the utterance voice processing unit 13 is transmitted by the communication control unit 12. The utterance data Dvo may include the positional information acquired by the positional information acquisition unit 17 from the navigation device 140, and the user profile 36, together with the voice data.

The recommendation information output unit 15 displays the recommendation screen on the touch panel 90 based on the recommendation information 35 when a specific action from which the user U is presumed to get out of the vehicle V is recognized by the user action recognition unit 11. The display to the touch panel 90 of the recommendation screen corresponds to output of the recommendation information. The output of the recommendation information may be performed by voice output from the speaker 91.

The service request reception unit 16 receives a request for product purchase or service provision in response to a touch operation of an order button displayed on the recommendation screen. The communication control unit 12 controls communication via the communication unit 130, and transmits purchase information to the information providing server 300 via the communication unit 130 when the request for product purchase or service provision is received by the service request reception unit 16. The service request reception unit 16 corresponds to one example of a reception unit. Note that the user terminal 150 may be used as the communication unit.

The communication control unit 12 transmits the positional information and the user profile 36 by the communication unit 130 in response to the request from the information providing server 300.

The communication control unit 12 transmits the utterance data Dvo generated by the utterance voice processing unit 13 by the communication unit 130.

The communication control unit 12 receives keyword information Dkw transmitted by the information providing server 300, extracts the trigger keyword 33 from the keyword information Dkw, and stores it in the storage unit 30. Also, the communication control unit 12 receives the recommendation information Dre transmitted by the information providing server 300 by the communication unit 130, extracts the recommendation information 35 from the recommendation information Dre, and stores it in the storage unit 30.

The speed recognition unit 18 recognizes speed of the vehicle V based on the detection signal of the speed sensor 120.

### [4. Configuration of Information Providing Server]

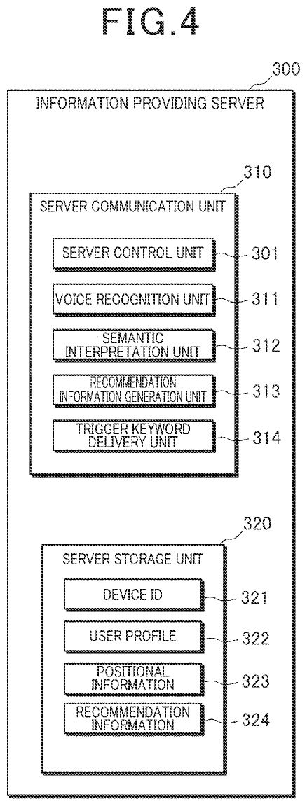

FIG. 4 is a block diagram illustrating a functional configuration of the information providing server 300. The information providing server 300 includes a server control unit 310 for controlling each unit of the information providing server 300, and a server storage unit 320 for storing a program and data. The server control unit 310 executes a control program (not shown) stored in the server storage unit 320 by a processor such as a CPU or microcomputer, and implements various functions of the information providing server 300. FIG. 4 illustrates, as functional units configured by the server control unit 310, a server communication unit 301, a voice recognition unit 311, a semantic interpretation unit 312, a recommendation information generation unit 313, and a trigger keyword delivery unit 314. These functional units are implemented by collaboration of software and hardware, for example, by the processor executing the program. The server control unit 310 may be equipped with hardware corresponding to these functional units. The server control unit 310 may include an interface circuit (not shown).

The server storage unit 320 is composed of a semiconductor memory or magnetic recording device, and stores a program and data in a non-volatile manner. The server storage unit 320 stores a device ID 321, a user profile 322, positional information 323, and recommendation information 324, in addition to the control program (not shown).

The device ID 321 is identification information specific to the information providing device 1. The information providing server 300 can store the device ID 321 for a plurality of information providing devices 1 that communicate with the information providing server 300.

The information providing server 300 includes an antenna for communicating with the information providing devices 1 and the webserver 410 through the communication network 500 by a function of the server communication unit 301 according to control of the server control unit 310.

For example, when the user profile 36 is received from the information providing device 1 by the function of the server communication unit 301, the server control unit 310 stores the received information as the user profile 322 in association with the device ID 321 in the server storage unit 320. Also, when the positional information is received from the information providing device 1 by the function of the server communication unit 301, the server control unit 310 stores the received information as the positional information 323 in association with the device ID 321 in the server storage unit 320.

The voice recognition unit 311 extracts voice data from the utterance data Dvo which the server control unit 310 receives from the information providing device 1 by the function of the server communication unit 301, and performs a recognition process for the extracted voice data. For example, the voice recognition unit 311 converts the voice data into text.

The semantic interpretation unit 312 interprets meaning of contents of the voice data based on a recognition result of the voice data by the voice recognition unit 311. For example, the semantic interpretation unit 312 interprets the contents uttered by the user U by executing morphological analysis and language analysis of the text data into which the voice recognition unit 311 has converted the voice data.

The recommendation information generation unit 313 generates the recommendation information 324 based on a result of interpretation of the semantic interpretation unit 312, and stores it in the server storage unit 320. For example, the recommendation information generation unit 313 collects information on a product or service fitting to the utterance contents interpreted by the semantic interpretation unit 312 from the webserver 410 or the like, and generates the recommendation information 324 for proposing the product or service to the user U. The recommendation information generation unit 313 may generate the recommendation information 324 using the user profile 322 and positional information 323 in addition to the result of the interpretation processing of the semantic interpretation unit 312. For example, the recommendation information generation unit 313 generates the recommendation information 324 on a product or service highly related to the user U's family structure or purchase history based on the user profile 322. For example, the recommendation information generation unit 313 generates the recommendation information 324 of a product related to the current position of the information providing device 1 or a service provided at a place near the current position of the information providing device 1 based on the positional information 323. The recommendation information generation unit 313 transmits the recommendation information Dre including the generated recommendation information 324 to the information providing device 1 by the server communication unit 301.

The trigger keyword delivery unit 314 generates the trigger keyword 33 at a preset cycle and generates the keyword information Dkw including the trigger keyword 33. The trigger keyword delivery unit 314 transmits the generated keyword information Dkw by the server communication unit 301.

### [5. Delivery of Trigger Keyword]

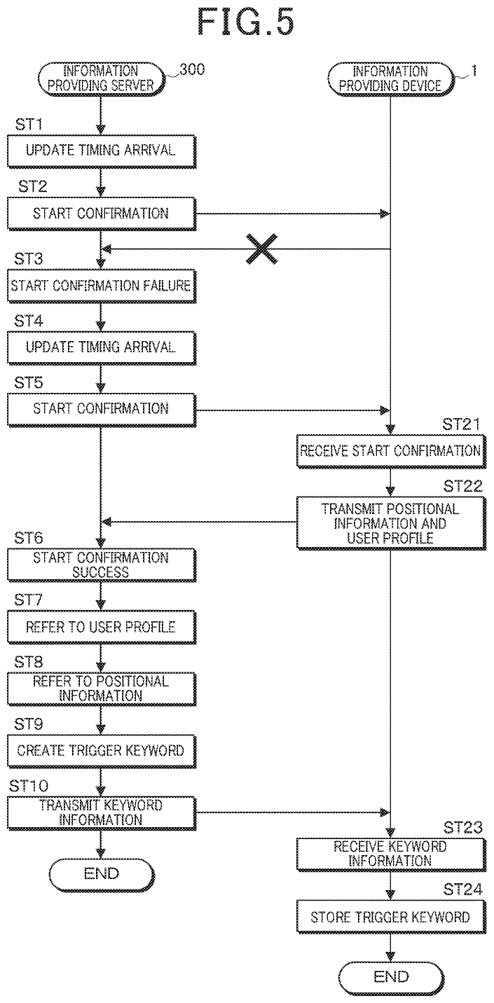

Operation of the information providing system 200 related to delivery of the trigger keyword 33 will be described with reference to a sequence diagram of FIG. 5.

When the information providing server 300 detects an arrival of update timing of the trigger keyword 33 based on a preset cycle (step ST1), the information providing server 300 transmits a start confirmation signal to the information providing device 1 (step ST2). When there are a plurality of information providing devices 1 to which the information providing server 300 delivers the trigger keyword 33, the information providing server 300 transmits the start confirmation to each information providing device 1. Here, when an information providing device 1 to which the start confirmation is transmitted is not operating, the information providing server 300 determines that the start confirmation has failed (step ST3) because there is no response from the information providing device 1. In this case, the information providing server 300 delivers the trigger keyword 33 to the information providing device 1 at the next update timing.

When the information providing server 300 detects an arrival of the next update timing (step ST4), the information providing server 300 transmits a start confirmation signal to the information providing device 1 (step ST5) as in step ST2. When the target information providing device 1 is operating, the information providing device 1 receives the start confirmation transmitted by the information providing server 300 (step ST21), and transmits a response including the positional information acquired by the positional information acquisition unit 17 and the user profile 36 to the information providing server 300 (step ST22).

The information providing server 300 receives the response from the information providing device 1 and determines that the start confirmation is a success (step ST6). Here, the information providing server 300 stores the user profile 36 transmitted by the information providing device 1 in the server storage unit 320 as the user profile 322. The information providing server 300 also stores the positional information transmitted by the information providing device 1 in the server storage unit 320 as the positional information 323.

The information providing server 300 refers to the user profile 322 (step ST7) and refers to the positional information 323 (step ST8). The information providing server 300 creates a trigger keyword based on the user profile 322 and positional information 323 (step ST9). The information providing server 300 transmits the keyword information Dkw including the created trigger keyword to the information providing device 1 (step ST10). The information providing device 1 receives the keyword information Dkw from the information providing server 300 (step ST23), extracts the trigger keyword 33 from the keyword information Dkw, and stores it in the storage unit 30 (step ST 24).

### [6. Output of Recommendation Information]

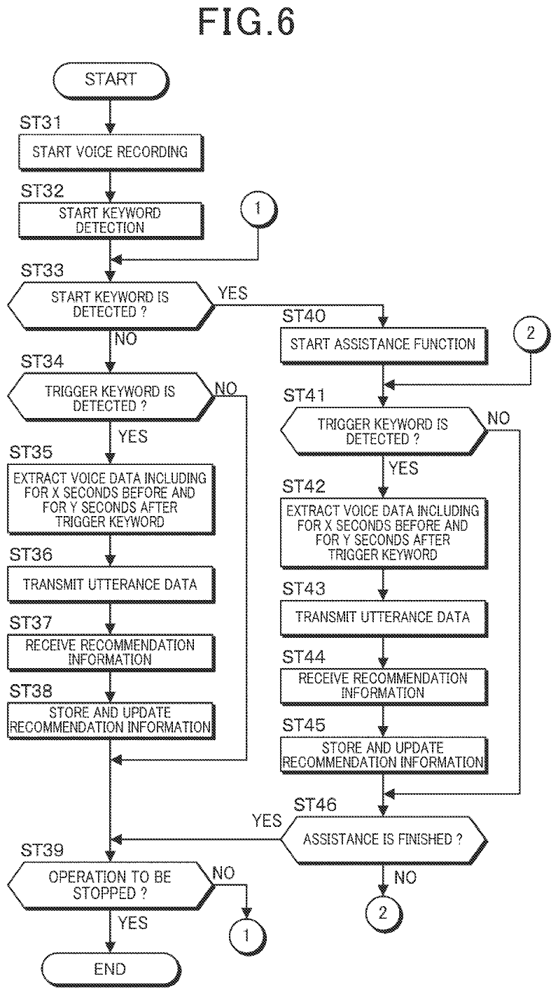

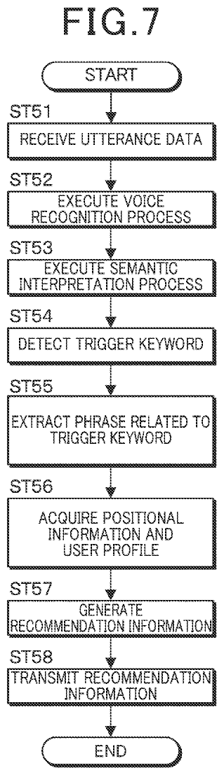

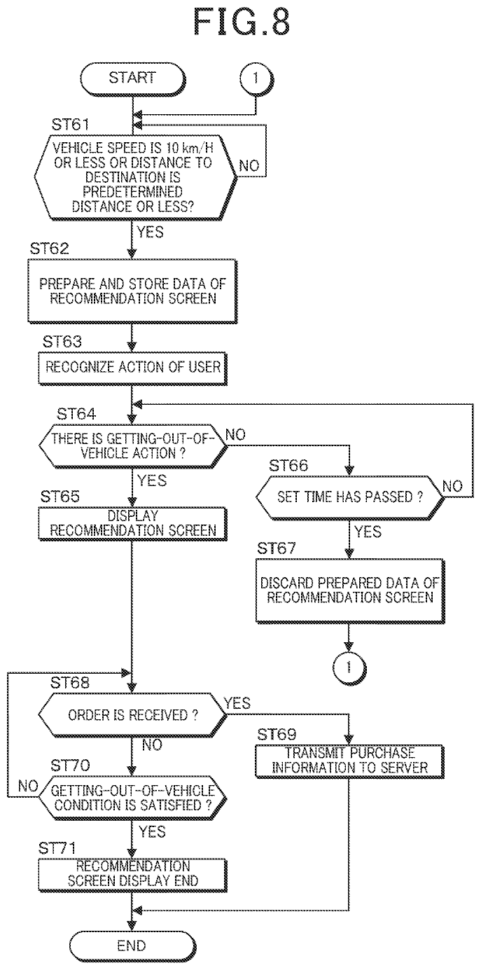

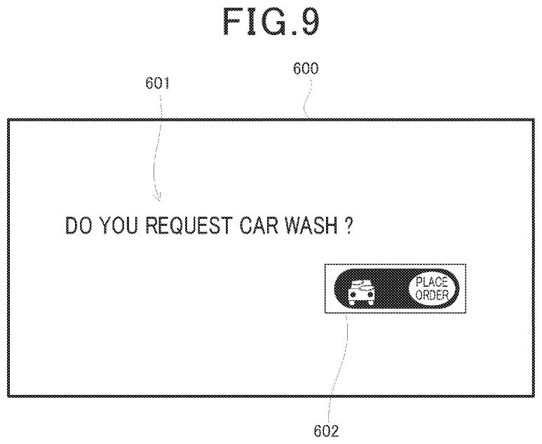

FIG. 6 is a flowchart illustrating operation of the information providing device 1, and illustrates operation related to detection of the trigger keyword 33. FIG. 7 is a flowchart illustrating operation of the information providing server 300 and illustrates operation related to transmission of the recommendation information. FIG. 8 is a flowchart illustrating operation of the information providing device 1 and illustrates operation related to output of the recommendation information. With reference to these FIGS. 6, 7, and 8 and an example of the recommendation screen of FIG. 9, operation of the information providing system 200 will be described.

The utterance voice processing unit 13 starts recording voice data based on the voice signal input from the microphone 92 (step ST31). After step ST31, the utterance voice processing unit 13 sequentially writes the voice data in the voice storage unit 32.

The keyword detection unit 14 starts detecting the trigger keyword 33 and start keyword 34 from the voice data generated by the utterance voice processing unit 13 (step ST32). The utterance voice processing unit 13 determines whether the keyword detection unit 14 has detected the start keyword 34 from the voice data (step ST33), and moves to step ST40 described later when determining that the start keyword 34 has been detected (step ST33; YES).

When the utterance voice processing unit 13 determines that the start keyword 34 has not been detected (step ST33; NO), the utterance voice processing unit 13 determines whether the keyword detection unit 14 has detected the trigger keyword 33 (step ST34). When the utterance voice processing unit 13 determines that the trigger keyword 33 has been detected (step ST34; YES), the utterance voice processing unit 13 extracts the voice data in the voice storage unit 32 (step ST35). In particular, in step ST35, the utterance voice processing unit 13 extracts voice data during X seconds before the trigger keyword 33, voice data corresponding to the trigger keyword 33, and voice data during Y seconds after the trigger keyword 33, from the voice data stored in the voice storage unit 32. X seconds and Y seconds are each the above predetermined time and are preset.

The utterance voice processing unit 13 generates utterance data Dvo including the voice data extracted in step ST35, and transmits it via the communication unit 130 by the communication control unit 12 (step ST36). In step ST36, the utterance voice processing unit 13 may generate and transmit the utterance data Dvo including the positional information acquired by the positional information acquisition unit 17 and the user profile 36 in addition to the voice data.

The communication control unit 12 receives the recommendation information Dre from the information providing server 300 by the communication unit 130 (step ST37), and stores it in the storage unit 30 as the recommendation information 35 (step ST38). When the storage unit 30 has already stored the recommendation information 35, the communication control unit 12 updates the recommendation information 35 in step ST38. In step ST38, the communication control unit 12 may replace the recommendation information 35, or may add contents of the recommendation information Dre received in step ST37 to the recommendation information 35 previously stored.

The control unit 10 determines whether to stop operation of the information providing device 1 (step ST39), and in the case of stopping the operation (step ST39; YES), performs a predetermined shutdown sequence, and terminates the process. In the case of not stopping the operation of the information providing device 1 (step ST39; NO), the control unit 10 returns to step ST33.

When the utterance voice processing unit 13 determines that the trigger keyword 33 has not been detected (step ST34; NO), the control unit 10 makes a determination in step ST39.

On the other hand, when the utterance voice processing unit 13 determines that the keyword detection unit 14 has detected the start keyword 34 (step ST33; YES), the control unit 10 starts an assistance function (step ST40). The assistance function is a function of answering to utterance of the user U by voice by the control unit 10 outputting the voice from the speaker 91, and having a pseudo free conversation. For example, the control unit 10 receives an instruction uttered by the user U, outputs voice indicating reception of the instruction to the user U from the speaker 91, and performs the instructed process.

The keyword detection unit 14 detects the trigger keyword 33 from the voice data on the utterance voice of the user U generated by the utterance voice processing unit 13 even during execution of the assistance function. The utterance voice processing unit 13 determines whether the keyword detection unit 14 has detected the trigger keyword 33 (step ST41). When the utterance voice processing unit 13 determines that the trigger keyword 33 has been detected (step ST41; YES), the utterance voice processing unit 13 extracts the voice data in the voice storage unit 32 (step ST42) as in step ST35.

The utterance voice processing unit 13 generates the utterance data Dvo including the voice data extracted in step ST42, and transmits it via the communication unit 130 by the communication control unit 12 (step ST43). In step ST43, the utterance voice processing unit 13 may generate and transmit the utterance data Dvo including the positional information acquired by the positional information acquisition unit 17 and the user profile 36 in addition to the voice data.

The communication control unit 12 receives the recommendation information Dre from the information providing server 300 by the communication unit 130 (step ST44), and stores it in the storage unit 30 as the recommendation information 35 (step ST45). The operations of steps ST44 and ST45 are the same as those of steps ST 37 and ST38. Then, the control unit 10 determines whether to stop the assistance function (step ST46). For example, in the case where stopping the assistance function is instructed by the utterance of the user U, the control unit 10 makes an affirmative determination in step ST46 (step ST46; YES). In this case, the control unit 10 moves to step ST39. In the case where stopping the assistance function is not instructed (step ST46; NO), the control unit 10 returns to step ST41.

The control unit 10 determines whether to stop the operation of the information providing device 1 (step ST39), and in the case of stopping the operation (step ST39; YES), performs the predetermined shutdown sequence, and terminates the process. In the case of not stopping the operation of the information providing device 1 (step ST39; NO), the control unit 10 returns to step ST33.

FIG. 7 illustrates operation which the information providing server 300 performs by the server control unit 310 in parallel with the operation of FIG. 6.

The server communication unit 301 receives the utterance data Dvo which the information providing device 1 transmits in steps ST 36 and ST43 (step ST51), and extracts the voice data from the utterance data Dvo. The voice recognition unit 311 performs the voice recognition process for the voice data received in step ST51 (step ST52). The semantic interpretation unit 312 performs a semantic interpretation process based on a result of the voice recognition process in step ST51 (step ST53).

The semantic interpretation unit 312 detects the trigger keyword 33 uttered by the user U from a result of semantic interpretation (step ST54). Furthermore, the semantic interpretation unit 312 extracts a phrase related to the trigger keyword 33 from contents uttered before and after the trigger keyword 33 (step ST55). For example, when the trigger keyword 33 is “car wash,” the semantic interpretation unit 312 extracts a phrase representing the user U's intention such as “do” and “want to do” or a phrase representing time such as “today” and “quickly.” The phrase extracted in step ST55 is combined with the trigger keyword 33 to indicate the user U's detailed request for what the trigger keyword 33 represents.

When the utterance data Dvo includes the positional information on the information providing device 1 and/or the user profile 36, the recommendation information generation unit 313 acquires the information (step ST56). The recommendation information generation unit 313 generates the recommendation information 324 (step ST57) based on the trigger keyword 33 detected by the semantic interpretation unit 312 in step ST54, the phrase extracted by the semantic interpretation unit 312 in step ST55, and the information acquired in step ST56. The recommendation information generation unit 313 generates the recommendation information Dre including the recommendation information 324 generated in step ST57, and transmits it to the information providing device 1 by the server communication unit 301 (step ST58).

In this way, the information providing device 1 detects the user U's utterance of the trigger keyword 33, and the information providing server 300 generates and transmits the recommendation information related to the trigger keyword 33 uttered by the user U to the information providing device 1. Thereby, useful information on a product or service related to contents of the utterance of the user U can be provided for the user U. The information providing device 1 stores the trigger keyword 33 delivered in advance from the information providing server 300, and can detect the trigger keyword 33 from the utterance of the user U by the function of the control unit 10. For this reason, the process of detecting the trigger keyword 33 can be quickly performed. Thereby, it is possible to respond to the utterance of the user U by quickly detecting the trigger keyword 33 without depending on a communication state between the information providing device 1 and information providing server 300. In addition, because the process of generating the recommendation information 324 is performed by the information providing server 300, it is possible to provide useful recommendation information with high accuracy without being restricted by the processing capability of the information providing device 1.

The operation of FIG. 8 is executed by the control unit 10 of the information providing device 1.

The recommendation information output unit 15 makes a determination by acquiring speed of the vehicle V detected by the speed recognition unit 18 and/or distance between a destination set in the navigation device 140 and the current position of the vehicle V, and waits until an affirmative determination is made (step ST61). In step ST61, the recommendation information output unit 15 determines whether the vehicle speed is equal to or less than 10 km/h, and/or determines whether the distance from the current position to the destination is equal to or less than a predetermined distance. That is, in step ST61, the recommendation information output unit 15 determines whether the vehicle V is in a state presumed to stop, and waits until the corresponding state is reached.

When the vehicle speed is equal to or less than 10 km/h, or the distance to the destination is equal to or less than the predetermined distance, the recommendation information output unit 15 makes an affirmative determination (step ST61; YES), and proceeds with the process.

The recommendation information output unit 15 prepares screen data for displaying the recommendation screen on the touch panel 90 based on the recommendation information 35, and temporarily stores it in the storage unit 30 (step ST62).

Now, one example of the recommendation screen is illustrated in FIG. 9.

A recommendation screen 600 illustrated in FIG. 9 includes a guide portion 601 and an order button 602. The guide portion 601 displays specific proposal contents for a product or service to the user U. In the example of FIG. 9, the guide portion 601 displays a message of proposing use of a car wash service. The order button 602 is an operation portion operated by the user U, and is a reception unit for receiving the operation of the user U. The order button 602 receives an application for purchase or use of the product or service displayed in the guide portion 601. In the example of FIG. 9, the order button 602 is a button, and when the user U touches the order button 602, an application for the car wash service is received.

The user action recognition unit 11 recognizes an action of the user U (step ST63). The recommendation information output unit 15 determines whether the specific action from which the user U is presumed to get out of the vehicle V has been recognized by the user action recognition unit 11 (step ST64).

The user action recognition unit 11 recognizes an off operation of the power switch 54 as the specific action from which the user U is presumed to get out of the vehicle V. The specific action from which the user U is presumed to get out of the vehicle may be recognized from an image captured by the front seat camera 45. It may be recognized that the user U has taken the specific action when a detection signal of the door switch 80 of the right front door 2 becomes off (door open state), when a shift position is changed to parking, when parking brake is applied, release of door lock, or when a detection signal of the seatbelt switch 60 of the driver's seat 7a is off (state in which the seatbelt is unfastened).

The specific action from which the user U is presumed to get out may include a condition that the position of the vehicle V is at specific places such as the user U's house and vehicle storage place.

When the user action recognition unit 11 recognizes the specific action (step ST64; YES), the recommendation information output unit 15 displays the recommendation screen on the touch panel 90 based on the data prepared in step ST62 (step ST65).

On the other hand, when the user action recognition unit 11 has not recognized the specific action (step ST64; NO), the recommendation information output unit 15 determines whether a preset time has passed since the preparation of the recommendation screen (step ST66). If the set time has not passed (step ST66; NO), the recommendation information output unit 15 returns to step ST64. If the set time has passed (step ST66; YES), the recommendation information output unit 15 discards the data created in step ST62 (step ST67), and returns to step ST61.

After displaying the recommendation screen, the recommendation information output unit 15 determines whether the operation of the user U is received by a reception unit of the touch panel 90 (step ST68).

When the recommendation information output unit 15 recognizes the touch operation of the user U by the reception unit (step ST68; YES), the service request reception unit 16 transmits purchase information indicating a purchase request for the car wash service to the information providing server 300 (step ST69). Thereby, the information providing server 300 transmits an instruction Gde to request the car wash service to the car wash service shop 450 via the webserver 410. As a result, the user U can request the car wash service shop 450 to wash the vehicle V.

When no operation is received (step ST68; NO), the recommendation information output unit 15 determines whether a getting-out-of-vehicle determination condition for determining whether the user U has got out of the vehicle V is satisfied (step ST70). In the embodiment, it is set, as the getting-out-of-vehicle determination condition, to recognize that the detection signal of the door switch 80 of the right front door 2 is switched from on (closed state detection)-off (open state detection) -on (closed state detection). Other than the determination by the door switch 80, or in addition to the determination by the door switch 80, the user U getting out of the vehicle V may be recognized by using a detection signal of a lock switch of the door lock mechanism 100 of the right front door 2, an image captured by the front seat camera 45, an image captured by the rear seat camera 46, an image captured by the right-side camera 41, or the like.

When the getting-out-of-vehicle determination condition is not satisfied (step ST70; NO), the recommendation information output unit 15 returns to step ST68. That is, until the getting-out-of-vehicle determination condition is satisfied, the recommendation information output unit 15 can receive the operation of the user U by a loop of steps ST68-ST70.

When the getting-out-of-vehicle determination condition is satisfied (step ST70; YES), the recommendation information output unit 15 ends the display of the recommendation screen on the touch panel 90.

### [7. Other Embodiments]

In the above embodiment, the car wash service is exemplified as the predetermined service of the present invention, but the predetermined service of the present invention is not limited to that. For example, the predetermined service may be a power supply service for electric vehicles, a delivery service of goods to the vehicle V, or the like. In addition, the predetermined service of the present invention is not limited to a service related to vehicles. For example, it may be delivery of daily necessities or food and drink to the user's house.

In the above embodiment, the four-wheeled vehicle V is exemplified as the movable body of the present invention, but the present invention is applicable to various passenger movable bodies such as a two-wheeled vehicle, a flying body, and a ship.

In the above-embodiment, the recommendation information output unit 15 displays the recommendation screen on the touch panel 90 and outputs the recommendation information. As another embodiment, instead of the display of the recommendation screen, or together with the display of the recommendation screen, the recommendation information may be output by outputting recommendation voice from the speaker 91. In this case, in addition to the touch operation to the touch panel 90, or instead of the touch operation, a request may be received by recognizing the user U's voice by the microphone 92.

The above embodiment exemplifies the configuration in which the information providing device 1 communicates with the information providing server 300 by using the communication unit 130 by the communication control unit 12, but the information providing device 1 may include a built-in wireless communication device. The information providing device 1 is not limited to one fixedly installed on the vehicle V, and, for example, a transportable device such as a smart phone and a mobile phone may be used as the information providing device 1. In addition, the user terminal 150 may have the function of the information providing device 1.

The above embodiment exemplifies the configuration in which the information providing device 1 includes the storage unit 30, and the storage unit 30 stores the recommendation information 35 generated by the information providing server 300 until the recommendation information output unit 15 outputs it. The present invention is not limited to this, and, for example, the information providing server 300 may store or retain the recommendation information until the recommendation information output unit 15 outputs the recommendation information 35.

The above embodiment exemplifies the configuration in which the information providing device 1 outputs the recommendation information, but the present invention is not limited to this, and, for example, the information providing server 300 may communicate with the user terminal 150, and output the recommendation information to the user terminal 150. In addition, the information providing server 300 may use a device different from the information providing device 1 and user terminal 150, and output the recommendation information.

In the above embodiment, although the recommendation information output unit 15 displays the recommendation screen on the touch panel 90 when a getting-out-of-vehicle action of the user U is recognized by the user action recognition unit 11, which is one example. The recommendation information output unit 15 may display the recommendation screen on the touch panel 90 when the vehicle V stops. For example, in step ST64, the recommendation information output unit 15 may determine whether the speed of the vehicle V is 0 km/h, and when it is 0 km/h, move to step ST65 and display the recommendation screen. For example, in step ST64, the recommendation information output unit 15 may determine whether the parking brake of the vehicle V is on, and display the recommendation screen when the parking brake is on. In the above embodiment, when the vehicle V starts travelling in the state of displaying the recommendation screen, the display of the recommendation screen may be temporarily stopped. In this case, when the vehicle V is stopped, the display of the recommendation screen may be resumed.

As another embodiment, when there are multiple pieces of recommendation information, priority may be set to the recommendation information, recommendation information with higher priority may be output during a first predetermined period from recognition of the user U's getting-out-of-vehicle action to completion of the user U's getting out, and recommendation information with lower priority may be output during a second predetermined period set other than the first predetermined period. Priority of the recommendation information is set higher, for example, as cost is higher, according to cost which a service provider pays for output of the recommendation information.

In the first predetermined period, the order button may be displayed as described above to enable immediate reception of order, and in the second predetermined period, the order button may be not displayed. Furthermore, in the first predetermined period, the recommendation information may be output by image display and voice, and in the second predetermined period, the recommendation information may be output by only voice.

FIGS. 3 and 4 are schematic diagrams showing the functional configurations of the information providing device 1 and information providing server 300 by classifying according to main processing contents, in order to facilitate understanding of the invention of the present application, and the configurations of the information providing device 1 and information providing server 300 may be configured according to other respective classifications. Processing of each component may be executed by one hardware unit, or may be executed by a plurality of hardware units. Processing of each component shown in FIGS. 5-8 may be executed by one program or may be executed by a plurality of programs.

### [8. Configuration Supported by Above Embodiments]

The above embodiments are specific examples of the following configurations.

### (Article 1)

An information providing system comprising a movable body terminal device disposed on a movable body and a server capable of communicating with the movable body terminal device, wherein: the movable body terminal device includes a terminal device-side processor, a terminal device-side memory, and a microphone for collecting voice uttered by a user on board the movable body, wherein the terminal device-side processor functions as a communication control unit for transmitting utterance data on the voice collected by the microphone; and the server includes a server-side processor, wherein the server-side processor functions as a server communication unit for receiving the utterance data, a voice recognition unit for recognizing utterance contents of the user based on the utterance data, a semantic interpretation unit for interpreting the utterance contents of the user based on a recognition result of the voice recognition unit, and a recommendation information generation unit for generating recommendation information of a product or service based on a result of interpretation processing of the semantic interpretation unit, wherein the terminal device-side processor functions as a recommendation information output unit for outputting the recommendation information during stop of the movable body.

According to the information providing system of Article 1, information on the product or service related to the contents uttered by the user of the movable body is provided when the movable body is stopped. Thereby, by outputting the recommendation information of the product or service in a state where the user is released from movement by the movable body and relaxed and able to pay attention to the recommendation information, useful information can be provided at appropriate timing.

### (Article 2)

The information providing system according to Article 1, wherein: the server outputs, by a function of the server communication unit, the result of the interpretation processing by a function of the semantic interpretation unit of the server-side processor and/or the recommendation information; and the terminal device-side processor of the movable body terminal device receives, by a function of the communication control unit, the result of the interpretation processing and/or the recommendation information, stores the result of the interpretation processing and/or the recommendation information in the terminal device-side memory, further functions as a user action recognition unit for recognizing the user's action, and outputs the recommendation information stored in the terminal device-side memory by a function of the recommendation information output unit when a specific action from which the user is presumed to get out of the movable body is recognized by a function of the user action recognition unit.

According to the information providing system of Article 2, since the recommendation information is output at timing when the user of the movable body is presumed to get out of the movable body, the recommendation information can be provided more effectively.

### (Article 3)

The information providing system according to Article 1 or 2, wherein: the terminal device-side processor of the movable body terminal device transmits positional information on the movable body to the server by a function of the communication control unit; and the server-side processor of the server receives the positional information on the movable body by a function of the server communication unit, and generates the recommendation information by a function of the recommendation information generation unit based on the positional information on the movable body and the result of the interpretation processing by a function of the semantic interpretation unit.

According to the information providing system of Article 3, more useful recommendation information generated by taking into account the contents uttered by the user of the movable body and the position of the movable body can be provided for the user.

### (Article 4)

The information providing system according to any one of Articles 1 to 3, wherein: the terminal device-side processor of the movable body terminal device transmits a user profile of the user to the server by a function of the communication control unit; and the server-side processor of the server receives the user profile by a function of the server communication unit, and generates the recommendation information by a function of the recommendation information generation unit based on the user profile and the result of the interpretation processing by a function of the semantic interpretation unit.

According to the information providing system of Article 4, more useful recommendation information generated by taking into account the contents uttered by the user of the movable body and the user profile can be provided for the user.

### (Article 5)

The information providing system according to any one of Articles 1 to 4, wherein: the server-side processor of the server transmits, by a function of the server communication unit, a trigger keyword that triggers transmission of the utterance data; and the terminal device-side processor of the movable body terminal device stores the trigger keyword received by a function of the communication control unit in the terminal device-side memory, further functions as a keyword detection unit for detecting the trigger keyword from the voice collected by the microphone, and transmits the utterance data on the utterance voice including the trigger keyword by a function of the communication control unit when the trigger keyword is detected by a function of the keyword detection unit.

According to the information providing system of Article 5, since the movable body terminal device detects the trigger keyword which triggers transmission of the utterance data, the trigger keyword can be promptly detected without communication between the movable body terminal device and server. This makes it possible to promptly respond to the utterance of the user and provide useful information for the user.

### (Article 6)

The information providing system according to Article 5, wherein: the terminal device-side memory stores the voice collected by the microphone; and the terminal device-side processor transmits, by the function of the communication control unit, the utterance data on an utterance voice including the trigger keyword and voice during a predetermined time before and after the utterance voice when the trigger keyword is detected by the function of the keyword detection unit.

According to the information providing system of Article 6, it is possible to generate more useful recommendation information based on the contents uttered by the user before and after the trigger keyword in addition to the trigger keyword, and provide the user.

### (Article 7)

An information providing device disposed on a movable body, the information providing device comprising a processor, a memory, and a microphone for collecting voice uttered by a user of the movable body, wherein: the processor functions as a communication control unit for transmitting utterance data on the voice collected by the microphone to a server and receiving recommendation information of a product or service generated by a server-side processor of the server based on the utterance data; the memory stores the recommendation information; and the processor functions as a recommendation information output unit for outputting the recommendation information during stop of the movable body.

According to the information providing device of Article 7, information on the product or service related to the contents uttered by the user of the movable body is provided when the movable body is stopped. Thereby, by outputting the recommendation information of the product or service in a state where the user is released from movement by the movable body and relaxed and able to pay attention to the recommendation information, useful information can be provided at appropriate timing.

### (Article 8)

The information providing device according to Article 7, wherein the processor functions as a user action recognition unit for recognizing an action of the user on board the movable body, and outputs the recommendation information stored in the memory by a function of the recommendation information output unit when a specific action from which the user is presumed to get out of the movable body is recognized by a function of the user action recognition unit.

According to the information providing device of Article 8, since the recommendation information is output at timing when the user of the movable body is presumed to get out of the movable body, the recommendation information can be provided more effectively.

### (Article 9)

The information providing device according to Article 7 or 8, wherein the processor functions as a service request reception unit for receiving a purchase operation based on the recommendation information, and transmits, by a function of the communication control unit, a purchase request based on the recommendation information output by a function of the recommendation information output unit when the purchase operation is received by a function of the service request reception unit.

According to the information providing device of Article 9, the user can easily purchase or use the proposed product or service based on the information provided by the information providing device.

### (Article 10)

A control method of an information providing device executed by a processor of the information providing device disposed on a movable body, the control method comprising: collecting voice uttered by a user of the movable body by a microphone; transmitting utterance data on the voice collected by the microphone to a server; receiving recommendation information of a product or service generated by a server-side processor of the server based on the utterance data; storing the recommendation information; and outputting the recommendation information during stop of the movable body.

According to the control method of the information providing device of Article 10, information on the product or service related to the contents uttered by the user of the movable body is provided when the movable body is stopped. Thereby, by outputting the recommendation information of the product or service in a state where the user is released from movement by the movable body and relaxed and able to pay attention to the recommendation information, useful information can be provided at appropriate timing.

### (Article 11)

A recording medium non-temporary, computer-readable, and having recorded a control program of an information providing device executed by a processor of the information providing device disposed on a movable body, wherein the control program causes the processor to: collect voice uttered by a user of the movable body by a microphone; transmit utterance data on the voice collected by the microphone to a server; receive recommendation information of a product or service generated by a server-side processor of the server based on the utterance data; store the recommendation information in a memory; and output the recommendation information during stop of the movable body.

According to the recording medium of Article 11,information on the product or service related to the contents uttered by the user of the movable body is provided by the information providing device when the movable body is stopped. Thereby, by outputting the recommendation information of the product or service in a state where the user is released from movement by the movable body and relaxed and able to pay attention to the recommendation information, useful information can be provided at appropriate timing.

### REFERENCE SIGNS LIST

1 . . . Information providing device (Movable body terminal device)
10 . . . Control unit
11 . . . User action recognition unit
12 . . . Communication control unit
13 . . . Utterance voice processing unit
14 . . . Keyword detection unit
15 . . . Recommendation information output unit
16 . . . Service request reception unit (reception unit)
17 . . . Positional information acquisition unit
18 . . . Speed recognition unit
30 . . . Storage unit (Keyword storage unit)
31 . . . Control program
32 . . . Voice storage unit
33 . . . Trigger keyword
34 . . . Start keyword
35 . . . Recommendation information
36 . . . User profile
90 . . . Touch panel
91 . . . Speaker
92 . . . Microphone
120 . . . Speed sensor
130 . . . Communication unit (Movable body communication unit)
140 . . . Navigation device
150 . . . User terminal
200 . . . Information providing system
300 . . . Information providing server
301 . . . Server communication unit
310 . . . Server control unit
311 . . . Voice recognition unit
312 . . . Semantic interpretation unit
313 . . . Recommendation information generation unit
314 . . . Trigger keyword delivery unit
320 . . . Server storage unit
321 . . . Device ID
322 . . . User profile
323 . . . Positional information
324 . . . Recommendation information
500 . . . Communication network
600 . . . Recommendation screen
601 . . . Guide portion
602 . . . Order button
Dkw . . . Keyword information
Dre . . . Recommendation information
Dvo . . . Utterance data
U . . . User
V . . . Vehicle (Movable body)

What is claimed is:

1. An information providing system comprising a movable body terminal device disposed on a movable body and a server capable of communicating with the movable body terminal device, wherein:
the movable body terminal device includes:
a terminal device-side processor;
a terminal device-side memory; and
a microphone for collecting voice uttered by a user on board the movable body,
wherein the terminal device-side processor
functions as a communication control unit for transmitting utterance data on the voice collected by the microphone; and
the server includes
a server-side processor,
wherein the server-side processor functions as
a server communication unit for receiving the utterance data,
a voice recognition unit for recognizing utterance contents of the user based on the utterance data,
a semantic interpretation unit for interpreting the utterance contents of the user based on a recognition result of the voice recognition unit, and
a recommendation information generation unit for generating recommendation information of a product or service based on a result of interpretation processing of the semantic interpretation unit,
wherein the terminal device-side processor
functions as a recommendation information output unit for outputting the recommendation information during stop of the movable body.

2. The information providing system according to claim 1, wherein:
the server
outputs, by a function of the server communication unit, the result of the interpretation processing by a function of the semantic interpretation unit of the server-side processor and/or the recommendation information; and
the terminal device-side processor of the movable body terminal device
receives, by a function of the communication control unit, the result of the interpretation processing and/or the recommendation information,
stores the result of the interpretation processing and/or the recommendation information in the terminal device-side memory,
further functions as a user action recognition unit for recognizing the user's action, and outputs the recommendation information stored in the terminal device-side memory by a function of the recommendation information output unit when a specific action from which the user is presumed to get out of the movable body is recognized by a function of the user action recognition unit.

3. The information providing system according to claim 1, wherein:
the terminal device-side processor of the movable body terminal device transmits positional information on the movable body to the server by a function of the communication control unit; and
the server-side processor of the server
receives the positional information on the movable body by a function of the server communication unit, and
generates the recommendation information by a function of the recommendation information generation unit based on the positional information on the movable body and the result of the interpretation processing by a function of the semantic interpretation unit.

4. The information providing system according to claim 1, wherein:
the terminal device-side processor of the movable body terminal device transmits a user profile of the user to the server by a function of the communication control unit; and
the server-side processor of the server
receives the user profile by a function of the server communication unit, and
generates the recommendation information by a function of the recommendation information generation unit based on the user profile and the result of the interpretation processing by a function of the semantic interpretation unit.

5. The information providing system according to claim 1, wherein:
the server-side processor of the server transmits, by a function of the server communication unit, a trigger keyword that triggers transmission of the utterance data; and
the terminal device-side processor of the movable body terminal device
stores the trigger keyword received by a function of the communication control unit in the terminal device-side memory,
further functions as a keyword detection unit for detecting the trigger keyword from the voice collected by the microphone, and
transmits the utterance data on the utterance voice including the trigger keyword by a function of the communication control unit when the trigger keyword is detected by a function of the keyword detection unit.

6. The information providing system according to claim 5, wherein:
the terminal device-side memory stores the voice collected by the microphone; and
the terminal device-side processor
transmits, by the function of the communication control unit, the utterance data on an utterance voice including the trigger keyword and voice during a predetermined time before and after the utterance voice when the trigger keyword is detected by the function of the keyword detection unit.

7. An information providing device disposed on a movable body, the information providing device comprising
a processor,
a memory, and
a microphone for collecting voice uttered by a user of the movable body, wherein:
the processor
functions as a communication control unit for transmitting utterance data on the voice collected by the microphone to a server and receiving recommendation information of a product or service generated by a server-side processor of the server based on the utterance data;
the memory stores the recommendation information; and
the processor
functions as a recommendation information output unit for outputting the recommendation information during stop of the movable body.

8. The information providing device according to claim 7,
wherein the processor
functions as a user action recognition unit for recognizing an action of the user on board the movable body, and
outputs the recommendation information stored in the memory by a function of the recommendation information output unit when a specific action from which the user is presumed to get out of the movable body is recognized by a function of the user action recognition unit.

9. The information providing device according to claim 7,
wherein the processor
functions as a service request reception unit for receiving a purchase operation based on the recommendation information, and
transmits, by a function of the communication control unit, a purchase request based on the recommendation information output by a function of the recommendation information output unit when the purchase operation is received by a function of the service request reception unit.

10. A control method of an information providing device executed by a processor of the information providing device disposed on a movable body, the control method comprising:
collecting voice uttered by a user of the movable body by a microphone;
transmitting utterance data on the voice collected by the microphone to a server;
receiving recommendation information of a product or service generated by a server-side processor of the server based on the utterance data;
storing the recommendation information; and
outputting the recommendation information during stop of the movable body.
